(19) United States
(12) Patent Application Publication
(10) Pub. No.: US 2016/0373965 A1
(43) Pub. Date: Dec. 22, 2016

(54) MOBILE COMMUNICATION DEVICE PERFORMANCE IMPROVEMENT BY OPTIMIZING CHANNEL HASHING

(71) Applicant: QUALCOMM Incorporated, San Diego, CA (US)

(72) Inventors: Bhaskara Viswanadham Batchu, Hyderabad (IN); Prabhanjan Reddy Pingili, Hyderabad (IN); Himanshu Agarwal, Hyderabad (IN); Sharad Shahi, Boulder, CO (US)

(21) Appl. No.: 14/744,491

(22) Filed: Jun. 19, 2015

(51) Int. Cl. H04W 28/08

(52) U.S. Cl. CPC H04W 28/085

(57) ABSTRACT

A method for channel hashing on a mobile communication device includes: performing a first channel hash on a first channel list; determining whether a hash channel selected by the first channel hash is the same as a serving channel to which the mobile communication device is latched; in response to determining that the hash channel selected by the first channel hash is not the same as the serving channel, generating a second channel list by removing one or more channels from the first channel list; and performing a second channel hash on the second channel list.

### BACKGROUND

A channel hashing mechanism is used by networks for load balancing. A mobile communication device performs a hash on a list of channels provided by a network to select a channel that the mobile communication device will monitor. The mobile communication device initially acquires a particular channel based on a preferred roaming list (PRL) and receives a channel list message on the acquired channel. The mobile communication device then hashes to one of the channels on the channel list based on the international mobile subscriber identification (IMSI) value of the mobile communication device. Since channel hashing is performed based on the constant IMSI value, if the mobile communication device receives the same channel list on every channel the mobile communication device monitors, the mobile communication device will hash to the same channel each time and will not switch back and forth between a certain set of channels.

However, if the mobile communication device receives non-identical channel lists on some of the channels the mobile communication device monitors, the mobile communication device can get stuck in a loop switching back and forth between a certain set of channels. For a multi-subscriber identity module multi-standby (MSMS) mobile communication device, if the back and forth switching happens in a small time period comparable to the time a radio access technology (RAT) takes for collecting overhead messages, mobile communication device performance will be impacted because the RAT will not release the RF chain to other RATs supported by the mobile communication device.

### SUMMARY

Apparatuses and methods for optimizing channel hashing are provided.

According to various embodiments there is provided a method. In some embodiments, the method may include: performing a first channel hash on a first channel list; determining whether a hash channel selected by the first channel hash is the same as a serving channel to which the mobile communication device is latched; in response to determining that the hash channel selected by the first channel hash is not the same as the serving channel, generating a second channel list by removing one or more channels from the first channel list; and performing a second channel hash on the second channel list.

According to various embodiments there is provided a mobile communication device. In some embodiments, the mobile communication device may include a storage unit and a control unit coupled to the storage unit.

The control unit may be configured to: perform a first channel hash on a first channel list; determine whether a hash channel selected by the first channel hash is the same as a serving channel to which the mobile communication device is latched; in response to determining that the hashed channel is not the same as a serving channel, generate a second channel list by removing one or more channels from the first channel list; and perform a second channel hash on the second channel list.

According to various embodiments there is provided an apparatus. In some embodiments, the apparatus may include: means for performing a first channel hash on a first channel list; means for determining whether a hash channel selected by the first channel hash is the same as a serving channel to which the mobile communication device is latched; in response to determining that the hash channel selected by the first channel hash is not the same as a serving channel, means for generating a second channel list by removing one or more channels from the first channel list based on a hash table; means for performing a second channel hash on the second channel list; means for determining whether a hash channel selected by the second channel hash is the same as the serving channel; in response to determining that the hash channel selected by the second channel hash is not the same as the serving channel, means for adding the serving channel to the hash table; and means for switching the serving channel to the hash channel selected by the second channel hash.

According to various embodiments there is provided a non-transitory computer readable medium. In some embodiments, the non-transitory computer readable medium may include instructions for causing one or more processors to perform operations including: performing a first channel hash on a first channel list; determining whether a hash channel selected by the first channel hash is the same as a serving channel to which the mobile communication device is latched; in response to determining that the hash channel selected by the first channel hash is not the same as the serving channel, generating a second channel list by removing one or more channels from the first channel list based on a hash table; performing a second channel hash on the second channel list; determining whether a hash channel selected by the second channel hash is the same as the serving channel; in response to determining that the hash channel selected by the second channel hash is not the same as the serving channel, adding the serving channel to the hash table after performing the second channel hash; and switching the serving channel to the hash channel selected by the second channel hash.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a diagram illustrating a conventional channel hashing algorithm;

FIG. 3 is a diagram illustrating a channel hashing algorithm according to various embodiments;

FIG. 4 is an illustration of a hash table according to various embodiments; and

FIG. 5 is a flowchart of a method according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

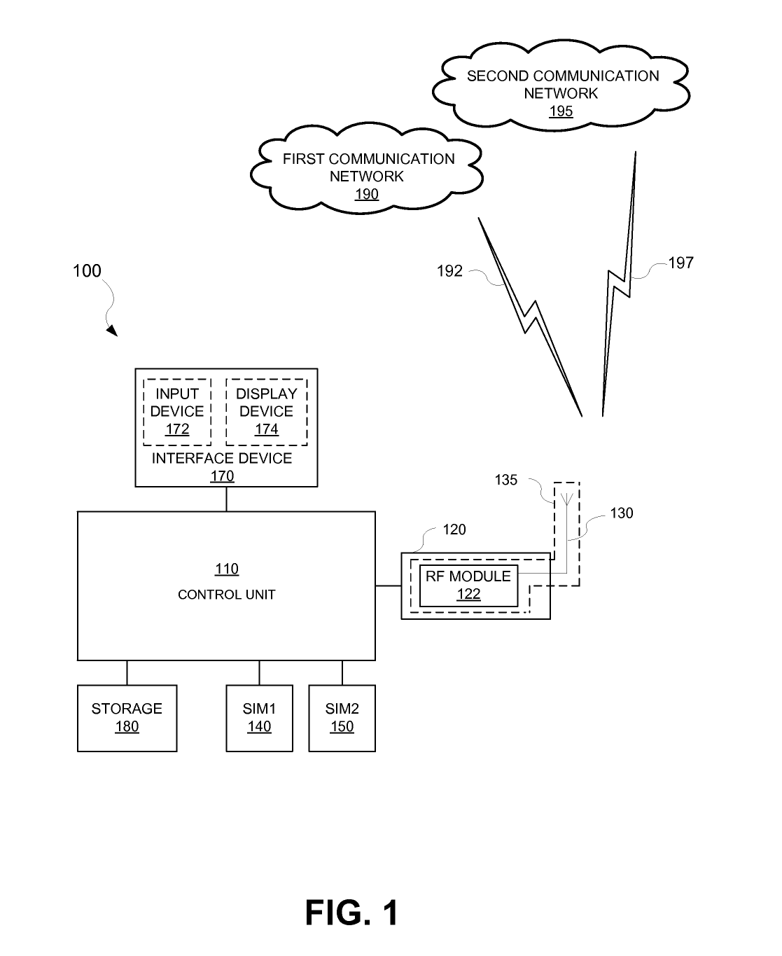

FIG. 1 is a block diagram illustrating a mobile communication device 100 according to various embodiments. As illustrated in FIG. 1, the mobile communication device 100 may include a control unit 110, a communication unit 120, an antenna 130, a first SIM 140, a second SIM 150, a user interface device 170, and a storage unit 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept.

A SIM (for example the first SIM 140 and/or the second SIM 150) in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The communication unit 120 may include, for example, but not limited to, an RF module 122. The RF module 122 may include, for example, but not limited to a first transceiver (not shown). An RF chain 135 may include, for example, but not limited to the antenna 130 and the RF module 122. The first SIM 140 may associate the communication unit 120 with a first subscription (Sub1) 192 on a first communication network 190 and the second SIM 150 may associate the communication unit 120 with a second subscription (Sub2) 197 on a second communication network 195.

The first communication network 190 and the second communication network 195 may be operated by the same or different service providers, and/or may support the same or different radio access technologies (RATs), for example, but not limited to, GSM, CDMA, WCDMA, and LTE.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the communication unit 120, the user interface device 170, and the storage unit 180. The control unit 110 may be a programmable device, for example, but not limited to, a microprocessor (e.g., general-purpose processor, baseband modem processor, etc.) or microcontroller.

The storage unit 180 may be configured to store application programs for operation of the mobile communication device 100 that are executed by the control unit 110, as well as application data and user data.

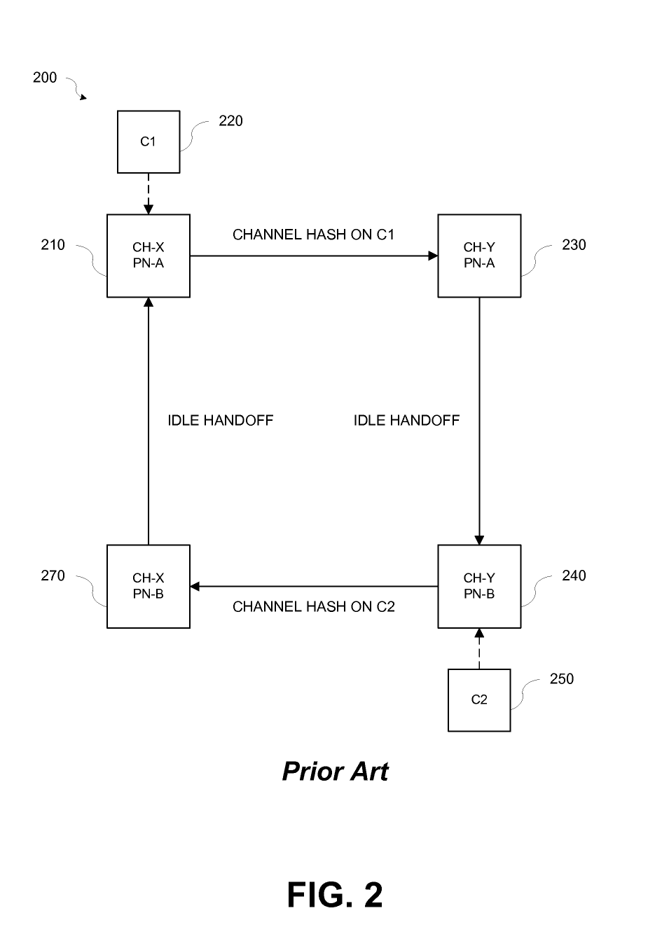

FIG. 2 is a diagram illustrating a conventional channel hashing algorithm 200. Referring to FIG. 2, a mobile communication device may acquire a channel X on pseudorandom noise (PN) code A (CH-X, PN-A) 210. The mobile communication device may receive first channel list (C1) 220 on CH-X, PN-A 210. Based on the IMSI, the mobile communication device may hash to CH-Y, PN-A 230. The hash channel may be a channel selected based on the received channel list by the channel hash to which the mobile communication device may reselect. The mobile communication device may then perform an idle handoff to CH-Y, PN-B 240 and receive a second channel list (C2) 250 on CH-Y, PN-B 240. Based on the IMSI, the mobile communication device may hash to CH-X, PN-B 270 and then perform an idle handoff back to CH-X, PN-A 210.

On CH-X, PN-A 210, the mobile communication device may again perform channel hashing to CH-Y, PN-A 230 and the above operations may continue to repeat causing the mobile communication device to become stuck in a loop monitoring the same four channels. Fast switching (e.g., on the order of ten seconds or less) between CH-X and CH-Y may impact mobile communication device performance since collection of overhead messages on each channel may take on of the order of two seconds.

Various embodiments provide a channel hash table to record the channels from which the mobile communication device has hashed. For each channel record in the channel hash table, the mobile communication device may maintain a timer for a specified amount of time. While performing any channel hashing, the mobile communication device may first determine a hashed channel from a channel list received from the network. If the hashed channel is the same as the current serving channel, the mobile communication device will continue monitoring the current serving channel. Otherwise, the mobile communication device will remove all channels present in the hash table from the received channel list to obtain a reduced channel list. The mobile communication device will then perform channel hashing on the reduced channel list to obtain a final hashed channel. The channels removed from the channel list remain in the hash table and be excluded from the channel list until their respective timers expire.

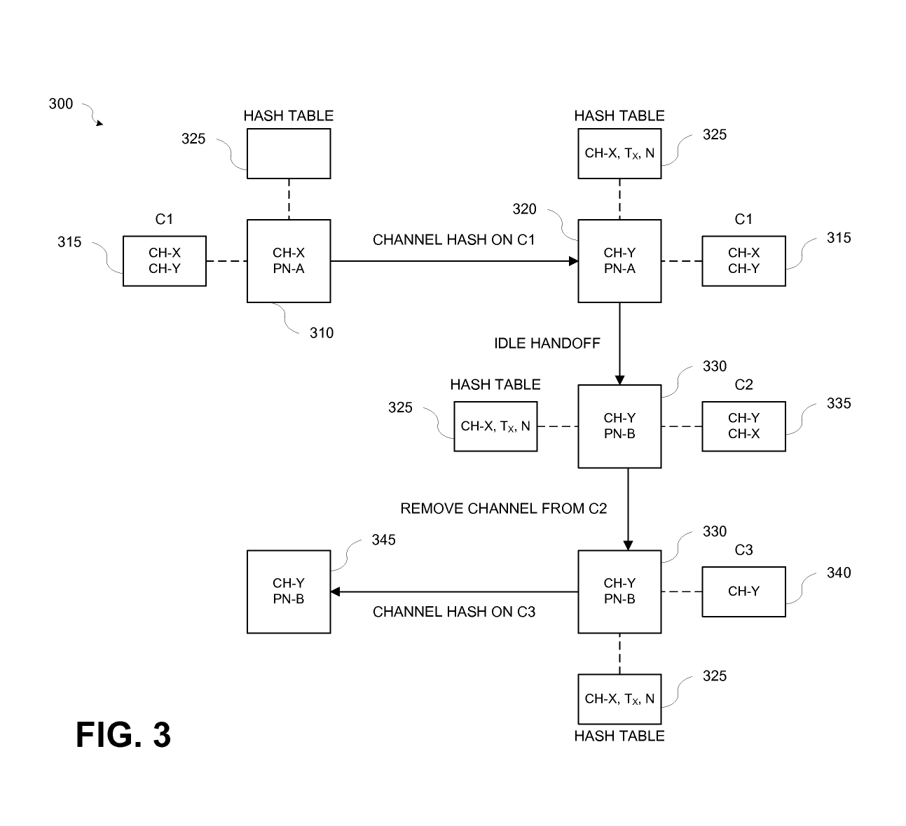

FIG. 3 is a diagram illustrating a channel hashing algorithm 300 according to various embodiments. Referring to FIGS. 1 and 3, a mobile communication device (e.g., the mobile communication device 100) may acquire CH-X, PN-A 310. The mobile communication device may receive a first channel list (C1) 315 on CH-X, PN-A 310. Based on the IMSI, the mobile communication device 100 may hash to CH-Y, PN-A 320. The hash channel (e.g., CH-Y, PN-A) may be a channel selected based on the received channel list by the channel hash to which the mobile communication device may reselect. The mobile communication device 100 may add CH-X to a channel hash table 325 and start a timer with value T seconds.

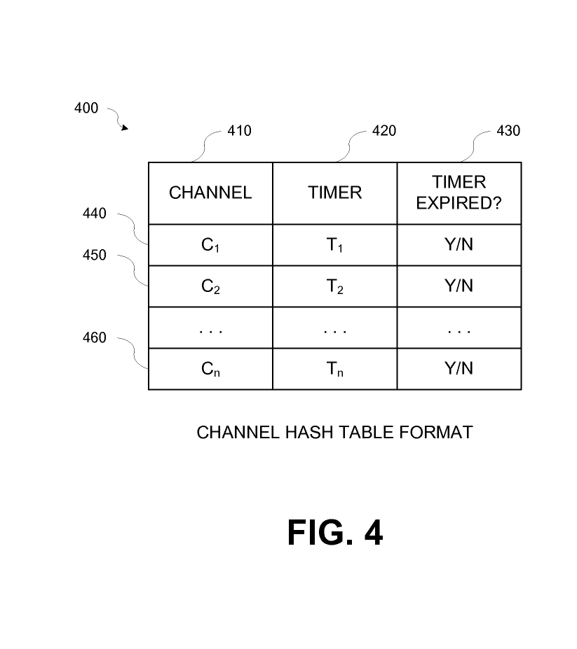

FIG. 4 is an illustration of a hash table 400 according to various embodiments. Referring to FIGS. 1, 3, and 4, the hash table 400, which may correspond to the channel hash table 325, may contain an entry for each channel 410 added to the hash table 400, an entry for a timer 420 associated with each channel, and an entry for an indication 430 of whether the timer 420 has expired 430. The timer 420 may be set (e.g., by the control unit 110) to time a period greater than the time necessary for the mobile communication device 100 to collect overhead messages from a network (e.g., on the order of ten seconds or more). When the timer 420 expires, the channel 410 corresponding to the expired timer 420 may be removed from the hash table 400. The hash table 400 may initially be empty.

The hash table 400 may be implemented in the storage unit 180 and/or may be implemented in internal storage of the control unit 110. The timer 420 may be implemented by the control unit 110 or may be implemented as circuitry separate from the control unit 110.

Returning to the algorithm 300, the mobile communication device 100 may then perform an idle handoff to CH-Y, PN-B 330 and receive a second channel list (C2) 335 on CH-Y, PN-B 330. If the mobile communication device 100 receives the second channel list (C2) 335 before the timer 420 expires, the mobile communication device 100 may remove CH-X (i.e., the channel in the hash table 400) from the second channel list (C2) 335 to generate a third (reduced) channel list (C3) 340. The mobile communication device 100 may hash on the third channel list (C3) 340 and therefore will not hash to CH-X, PN-B.

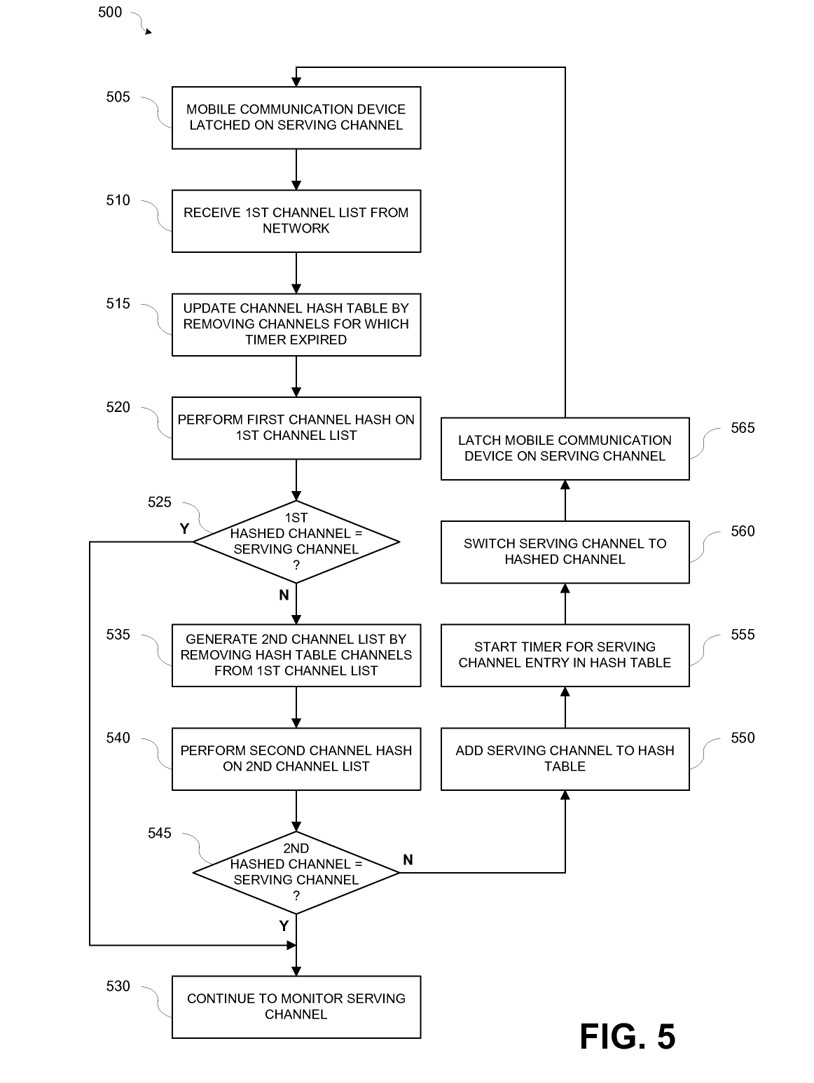

FIG. 5 is a flowchart of a method 500 according to various embodiments. Referring to FIGS. 1 and 3-5, the mobile communication device 100 may be latched on a serving channel (505). While latched on the serving channel, the mobile communication device 100 may receive a first channel list from a network (e.g., a first communication network 190) (510). The control unit 110 may cause an update to the hash table 400 by removing channels 410 for which a timer 420 has expired (515). For example, a timer 420 may be set for each channel 410 added to the hash table 400, and the channel 410 may remain in the hash table 400 until the timer 420 expires. While a channel 410 remains in the hash table 400, the channel 410 may be excluded to generate a reduced channel list.

The control unit 110 may cause the mobile communication device 100 to perform a first channel hash on the first channel list (520). Channel hashing may be performed based on the constant IMSI value of the mobile communication device 100. Then, the control unit 110 may determine whether the channel to which the mobile communication device 100 hashes on the first channel list is the same as the serving channel (525). If the channel to which the mobile communication device 100 hashes on the first channel list is the same as the serving channel (525-Y), the control unit 110 may cause the communication unit 120 to continue to monitor the serving channel (530).

If the channel to which the mobile communication device 100 hashes to is not the same as the serving channel (525-N), the control unit 110 may generate a second (reduced) channel list 335 by removing one or more channels contained in the hash table 400 from the first channel list received from the network (535). For example, any channel in the hash table 400 that has an indication 430 that the timer 420 associated with the channel 410 has not expired may be removed from the first channel list to generate the second (reduced) channel list. The control unit 110 may cause the mobile communication device 100 to perform a second channel hash on the second channel list (540).

Then, the control unit 110 may determine whether the channel to which the mobile communication device 100 hashes on the second channel list is the same as the serving channel (545). If the channel to which the mobile communication device 100 hashes on the second channel list is the same as the serving channel (545-Y), the control unit 110 may cause the communication unit 120 to continue to monitor the serving channel (530). If the channel to which the mobile communication device 100 hashes is not the same as the serving channel (545-N), the control unit 110 may add an entry corresponding to the serving channel to the hash table 400 (550). The control unit 110 may start a timer 420 associated with the serving channel entry in the hash table 400 (555). For example, the control unit 110 may set the timer 420 to time a period greater than the time necessary for the mobile communication device 100 to collect overhead messages from a network (e.g., on the order of ten seconds or more).

The control unit 110 may cause the communication unit 120 to switch the serving channel for the mobile communication device 100 to the hashed channel (560). The control unit 110 may cause the mobile communication device 100 to latch on the new serving channel (565).

The method 500 described with respect to FIG. 5 may be embodied on a non-transitory computer readable medium, for example, but not limited to, the storage unit 180 or other non-transitory computer readable medium known to those of skill in the art, having stored therein a program including computer executable instructions for making a processor, computer, or other programmable device execute the operations of the methods.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method for channel hashing on a mobile communication device, the method comprising:
performing a first channel hash on a first channel list;
determining whether a hash channel selected by the first channel hash is the same as a serving channel to which the mobile communication device is latched;
in response to determining that the hash channel selected by the first channel hash is not the same as the serving channel, generating a second channel list by removing one or more channels from the first channel list; and
performing a second channel hash on the second channel list.

2. The method of claim 1, wherein the one or more channels removed from the first channel list are determined based on a hash table stored on the mobile communication device.

3. The method of claim 2, further comprising starting a timer associated with each channel in the hash table.

4. The method of claim 3, wherein the timer is configured to expire after a time period greater than a time required for the mobile communication device to collect overhead messages from a network.

5. The method of claim 3, further comprising removing a channel for which the timer expires from the hash table.

6. The method of claim 1, further comprising:
determining whether a hash channel selected by the second channel hash is the same as the serving channel; and
in response to determining that the hash channel selected by the second channel hash is not the same as the serving channel, adding the serving channel to a hash table stored on the mobile communication device.

7. The method of claim 6, further comprising:
starting a timer associated with the serving channel added to the hash table;
wherein the timer is configured to time a period greater than a time required for the mobile communication device to collect overhead messages from a network.

8. The method of claim 6, further comprising switching the serving channel for the mobile communication device to the hash channel selected by the second channel hash.

9. The method of claim 1, further comprising in response to determining that the hash channel is the same as the serving channel, continuing to monitor the serving channel.

10. A mobile communication device, comprising:
a storage unit; and
a control unit coupled to the storage unit, the control unit configured to:
perform a first channel hash on a first channel list;
determine whether a hash channel selected by the first channel hash is the same as a serving channel to which the mobile communication device is latched;
in response to determining that the hashed channel is not the same as a serving channel, generate a second channel list by removing one or more channels from the first channel list; and
perform a second channel hash on the second channel list.

11. The mobile communication device of claim 10, wherein the control unit is configured to determine the one or more channels removed from the first channel list based on a hash table stored on the storage unit.

12. The mobile communication device of claim 11, wherein the control unit is configured to start a timer associated with each channel in the hash table.

13. The mobile communication device of claim 12, wherein the timer is configured to expire after a time period greater than a time required for the mobile communication device to collect overhead messages from a network.

14. The mobile communication device of claim 12, wherein the control unit is configured to remove a channel for which the timer expires from the hash table.

15. The mobile communication device of claim 10,
wherein the control unit is configured to:
determine whether the hash channel selected by the second channel hash is the same as the serving channel after performing the second channel hash on the second channel list; and
in response to determining that the hash channel is not the same as the serving channel, add the serving channel to a hash table stored on the storage unit after performing the second channel hash.

16. The mobile communication device of claim 15, wherein the control unit is configured to:
start a timer associated with the serving channel added to the hash table,
wherein the timer is configured to time a period greater than a time required for the mobile communication device to collect overhead messages from a network.

17. The mobile communication device of claim 15, wherein the control unit is configured to switch the serving channel for the mobile communication device to the hash channel after performing the second channel hash.

18. The mobile communication device of claim 10, wherein in response to determining that the hash channel is the same as the serving channel, the control unit is configured to continue monitoring the serving channel.

19. An apparatus, comprising:
means for performing a first channel hash on a first channel list;
means for determining whether a hash channel selected by the first channel hash is the same as a serving channel to which the mobile communication device is latched;
in response to determining that the hash channel selected by the first channel hash is not the same as a serving channel, means for generating a second channel list by removing one or more channels from the first channel list based on a hash table;
means for performing a second channel hash on the second channel list;
means for determining whether a hash channel selected by the second channel hash is the same as the serving channel;
in response to determining that the hash channel selected by the second channel hash is not the same as the serving channel, means for adding the serving channel to the hash table; and
means for switching the serving channel to the hash channel selected by the second channel hash.

20. The apparatus of claim 19, further comprising:
means for starting a timer associated with the serving channel added to the hash table,
wherein the timer is configured to time a period greater than a time required for collecting overhead messages from a network.

21. A non-transitory computer readable medium having stored thereon instructions for causing one or more processors to perform operations comprising:
performing a first channel hash on a first channel list;
determining whether a hash channel selected by the first channel hash is the same as a serving channel to which the mobile communication device is latched;
in response to determining that the hash channel selected by the first channel hash is not the same as the serving channel, generating a second channel list by removing one or more channels from the first channel list based on a hash table;
performing a second channel hash on the second channel list;
determining whether a hash channel selected by the second channel hash is the same as the serving channel;
in response to determining that the hash channel selected by the second channel hash is not the same as the serving channel, adding the serving channel to the hash table after performing the second channel hash; and
switching the serving channel to the hash channel selected by the second channel hash.

22. The non-transitory computer readable medium as defined in claim 21, further comprising instructions to perform operations comprising:
starting a timer associated with the serving channel added to the hash table,
wherein the timer is configured to time a period than a time required for collecting overhead messages from a network.
